(19) United States
(12) Patent Application Publication
(10) Pub. No.: US 2013/0151700 A1
(43) Pub. Date: Jun. 13, 2013

(54) NEE INDICATING METHOD, INDICATOR AND SYSTEM

(71) Applicant: Huawei Technologies Co., Ltd., Shenzhen (CN)

(72) Inventors: Xuanpeng Liu, Shezhen (CN); Xiaoming Duan, Shenzhen (CN); Xiwen Zhang, Shenzhen (CN)

(73) Assignee: Huawei Technologies Co., Ltd., Shenzhen (CN)

(21) Appl. No.: 13/761,927

(22) Filed: Feb. 7, 2013

Related U.S. Application Data
(63) Continuation of application No. PCT/CN2011/074843, filed on May 30, 2011.

(30) Foreign Application Priority Data
Aug. 17, 2010 (CN) 201010257521.7

(51) Int. Cl. H04L 12/26

(52) U.S. Cl. CPC H04L 43/0876
USPC 709/224

(57) ABSTRACT

Embodiments of the present invention disclose a network energy efficiency (NEE) indicating method, which is used to display NEE status with high efficiency and real-time. The method according to embodiments of the present invention comprises: obtaining report data which are reported by network element(s); performing pre-analysis process on the report data to get valid data used for obtaining a NEE parameter, wherein the valid data are taken as pre-analysis result which includes traffic amount data and power consumption data; obtaining the NEE parameter according to the traffic amount data and the power consumption data; and displaying the obtained NEE parameter. The embodiments of the present invention also disclose a NEE indicator and a NEE indicating system. The embodiments of the present invention can display the NEE status with high efficiency and real-time.

### CROSS-REFERENCE TO RELATED APPLICATIONS

This application is a continuation of International Application No. PCT/CN2011/074843, filed on May 30, 2011, which claims priority to Chinese Patent Application No. 201010257521.7, filed on Aug. 17, 2010, both of which are hereby incorporated by reference in their entireties.

### FIELD OF TECHNOLOGY

The present invention relates to communication technology field, and in particularly to a network energy efficiency (NEE) indicating method, a NEE indicator and a NEE indicating system.

### BACKGROUND

In mobile communication networks, along with the increase of the number of users and the rapid increase of data traffic, the communication traffic amount increases rapidly. There is an increasing trend in the energy consumption of the mobile networks. The operators are more and more concerned about the energy efficiency condition of the networks, which is usually described with a NEE parameter.

However, in the prior art, the query work for traffic amount data is performed by persons completely. The energy consumption data are also obtained by manual computation based on some percent of electricity fee bills. In this way there is large work load, high cost, and it is difficult to ensure the accuracy of the data.

Furthermore, the bills of electricity fee can only be obtained once a month or in a longer period, resulting that the calculated NEE parameter cannot be obtained in real time.

### SUMMARY

Embodiments of the present invention provide a NEE indicating method, a NEE indicator and a NEE indicating system, which can display the NEE status efficiently and in real time.

An embodiment of the present invention provides a method for indicating NEE, comprising: obtaining report data which are reported by one or more network elements; performing pre-analysis process on the report data to get valid data used for obtaining a NEE parameter, wherein the valid data are taken as pre-analysis result, and the pre-analysis result includes traffic amount data and power consumption data; obtaining the NEE parameter according to the traffic amount data and the power consumption data; and displaying the obtained NEE parameter.

An embodiment of the present invention provides a NEE indicator, which comprises: a data obtaining module for obtaining report data which are reported by one or more network elements; a pre-analyzing module for performing pre-analysis process on the report data to get valid data used for obtaining a NEE parameter, wherein the valid data are taken as pre-analysis result, and the pre-analysis result includes traffic amount data and power consumption data; a NEE parameter obtaining module for obtaining the NEE parameter according to the traffic amount data and the power consumption data; a NEE parameter displaying module for displaying the obtained NEE parameter.

An embodiment of the present invention provides a NEE indicating system, the system comprises a NEE indicator and one or more network elements which are the objects to be monitored for NEE.

It can be seen from the above technical solutions, embodiments of the present invention provide the following advantages.

In the embodiments of the present invention, the NEE indicator can obtain report data from the network element(s), and can get valid data used for obtaining NEE parameter after performing pre-analysis process on the report data. The valid data include traffic amount data and power consumption data. That is to say, it is not necessary for a person to manually obtain the traffic amount data and the power consumption data, which thus can be monitored and obtained in real time, so as to improve real time performance for obtaining the NEE parameter.

Moreover, the NEE indicator calculates the NEE parameter after obtaining the traffic amount data and the power consumption data. In this way, both the process of obtaining the traffic amount data and the power consumption data and the process of calculating the NEE parameter are performed by the NEE indicator automatically. Therefore it can reduce the person's manual workload, save time, decrease the cost of operation, and at the same time improve the data accuracy.

### BRIEF DESCRIPTION OF THE DRAWINGS

FIG. 1 is a diagram illustrating a method for indicating NEE according to an embodiment of the present invention.

FIG. 2 is a diagram illustrating a method for indicating NEE according to another embodiment of the present invention.

FIG. 3 is a diagram illustrating the location relationship of respective devices according to an embodiment of the present invention.

FIG. 4 is a diagram illustrating a method for indicating NEE according to another embodiment of the present invention.

FIG. 5 is a diagram illustrating a method for indicating NEE according to another embodiment of the present invention.

FIG. 6 is a diagram illustrating the output effect of a method for indicating NEE according to an embodiment of the present invention.

FIG. 7 is a diagram illustrating a NEE indicator according to an embodiment of the present invention.

FIG. 8 is a diagram illustrating a NEE indicator according to another embodiment of the present invention.

FIG. 9 is a diagram illustrating a NEE indicator according to another embodiment of the present invention.

FIG. 10 is a diagram illustrating a NEE indicating system according to an embodiment of the present invention.

### DETAILED DESCRIPTION

Embodiments of the present invention provide a NEE indicating method, which can present the NEE condition efficiently and in real time.

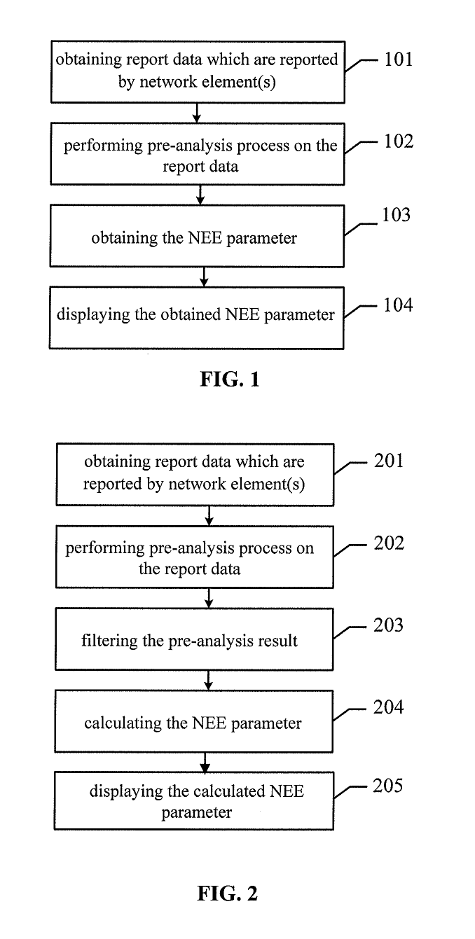

FIG. 1 illustrates a NEE indicating method according to a specific embodiment of the present invention. The method comprises:

101: obtaining report data which are reported by one or more network elements;

The NEE indicator obtains the report data which are reported by the one or more network elements. The report data may be massive data which are reported by the one or more network elements according to a default protocol, and may also be data which are reported by the one or more network elements according to the request of the NEE indicator. The report data is not limited to a specific implementation.

In the present embodiment, the NEE indicator may obtain the report data through various ways, which will be described in detail in the following embodiments.

102: performing pre-analysis process on the report data;

After obtaining the report data, the NEE indicator may perform pre-analysis process on the report data to get valid data used for obtaining a NEE parameter. The valid data may be taken as pre-analysis result which includes traffic amount data and power consumption data.

In the present embodiment, the main purpose for the NEE indicator to perform the pre-analysis process on the report data lies in that: selecting, out of the report data, data which are valid for the process of obtaining the NEE parameter, the valid data include at least traffic amount data and power consumption data.

103: obtaining the NEE parameter;

In the present embodiment, the traffic amount data and the power consumption data are obtained after the pre-analysis process. The NEE indicator obtains the NEE parameter according to the traffic amount data and the power consumption data. It can be seen from the definition of the NEE parameter, the value of the NEE parameter is related to the traffic amount data and the power consumption data. Therefore the NEE parameter may be obtained according to the traffic amount data and the power consumption data. The specific way for obtaining the NEE parameters is not limited herein.

104: displaying the obtained NEE parameter.

After obtaining the NEE parameter, the NEE indicator may display the NEE parameter in order for a user to inquire, output or print.

In the present embodiment, the NEE indicator can acquire the report data from the one or more network elements, and can acquire the valid data used for obtaining the NEE parameter after performing pre-analysis process on the report data. The valid data include the traffic amount data and the power consumption data. That is, the traffic amount data and the power consumption data need not to be obtained manually, and thus may be monitored and obtained in real-time, improving the real time performance for obtaining the NEE parameter.

And the NEE indicator calculates the NEE parameter after obtaining the traffic amount data and the power consumption data. Therefore both the process of obtaining the traffic amount data and the power consumption data and the process of calculating the NEE parameter are completed automatically by the NEE indicator. In this way it can reduce the manual workload, save time, decrease the operation cost, and at the same time improve the data accuracy.

For the sake of facilitating understanding, a NEE indicating method according to another embodiment of the present invention will be described below in conjunction with FIG. 2. The method according to the another embodiment of the present invention comprises:

201: obtaining report data which are reported by network element(s);

The step 201 in the present embodiment is the same as the step 101 in the above mentioned embodiment as shown in FIG. 1, and thus is not described in detail here.

202: performing pre-analysis process on the report data;

After obtaining the report data, the NEE indicator may perform pre-analysis process on the report data to get valid data used for obtaining NEE parameter. The valid data may be taken as pre-analysis result which includes traffic amount data and power consumption data.

In the present embodiment, the main purpose for the NEE indicator to perform the pre-analysis process on the report data lies in that: selecting, out of the report data, data which are valid for the process of obtaining the NEE parameter. The valid data include at least the traffic amount data and the power consumption data.

The specific pre-analysis process in an actual application may include integrality process and/or validity process. The integrality process is used to select, from the report data, data whose parameter fields are integral. The validity process is used to select, from the report data, normally reported data used for obtaining the NEE parameter.

It should be noted that in the present embodiment it just describes the pre-analysis process by using several examples. It should be understood that there may be other ways to implement the pre-analysis process in actual applications. The specific ways to implement the pre-analysis process are not limited herein.

203: filtering the pre-analysis result;

After the performing the pre-analysis process on the report data to get the pre-analysis result, the NEE indicator may also filter the pre-analysis result to get the filtered data.

In the present embodiment, the following filtering ways may be employed particularly:

the pre-analysis result may be filtered according to an obtained pre-configured network element set, the network element set indicates one or more network elements for which the user desires to obtain the NEE parameter, then the traffic amount data and the power consumption data reported by the network element(s) corresponding to the network element set are filtered out as the filtered data; or

the pre-analysis result may be filtered according to an obtained pre-configured time region, the time region includes a start time, an analysis interval and an end time, then in a time period from the start time to the end time, the traffic amount data and the power consumption data are filtered according to the analysis interval to acquire the filtered data; or

the pre-analysis result may be filtered according to both an obtained pre-configured network element set and an obtained pre-configured time region, the network element set indicates the network element(s) for which the user desires to obtain the NEE parameter, the time region includes a start time, an analysis interval and an end time, then the traffic amount data and the power consumption data reported by the network element(s) corresponding to the network element set are filtered out of the received traffic amount data and power consumption data, and in a time period from the start time to the end time, the traffic amount data and the power consumption data reported by the network element(s) corresponding to the network element set are filtered according to the analysis interval to acquire the filtered data.

It should be noted that the above illustrated filtering ways are just be used to describe the filtering process by way of several examples. It should be understood that there may be more ways to implement the filtering process. The specific ways to implement the filtering process are not limited herein.

204: calculating the NEE parameter;

After getting the filtered data, the NEE indicator may calculate the NEE parameter according to the filtered data. Since the filtered data are filtered out of the pre-analysis result, the filtered data may also include at least traffic amount data and power consumption data. Therefore the NEE indicator may also perform calculation on the filtered data to get the NEE parameter.

205: displaying the obtained NEE parameter.

The step 205 in the present embodiment is the same as the step 104 in the above mentioned embodiment as shown in FIG. 1, and thus is not described in detail here.

Comparing with the above mentioned embodiment as shown in FIG. 1, a process of filtering the pre-analysis result is added in the present embodiment. Therefore the present embodiment further has the following advantageous effects in addition to the advantageous effects presented in the above mentioned embodiment as shown in FIG. 1:

In the present embodiment, after performing pre-analysis process on the report data to acquire the pre-analysis result, the NEE indicator may also filter the pre-analysis result. In this way the NEE indicator may filter out of the pre-analysis result specific data used for calculating the NEE parameter, and thus it may improve the flexibility and pertinence of the process for calculating the NEE parameter.

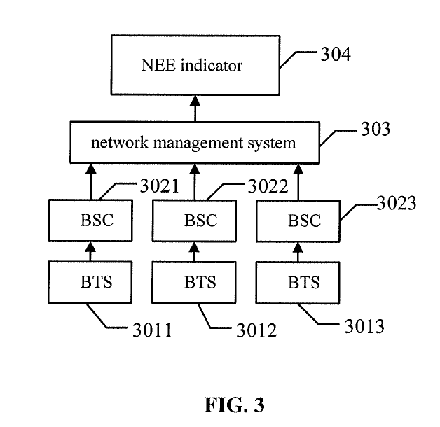

In order for convenient understanding of the relationship among the steps in the above mentioned embodiments, it is described in the following by way of example that three base station send the report data to a network management system and the NEE indicator receives the report data. Please refer to FIG. 3 which shows the position relationship among the respective devices. In FIG. 3, the base stations (BTSs, Base Transceiver Station) 3011, 3012 and 3013 respectively send the report data to the network management system 303 via the Base Station Controllers (BSCs) 3021, 3022 and 3023, and the network management system 303 sends the report data to the NEE indicator 304.

It should be noted that, in the present embodiment the NEE indicator 304 and the network management system 303 are illustrated as being implemented separately, however it should be understood that the NEE indicator 304 may be integrated in the network management system 303 in actual applications.

When the NEE indicator and the network management system are implemented separately, the base stations send the report data to the network management system via the base station controllers, and then the network management system forwards the received report data to the NEE indicator for further process.

When the NEE indicator is integrated in the network management system, the NEE indicator acts as a unit or a module of the network management system. In this way, the NEE indicator may directly receive the report data sent by the base stations via the base station controllers and perform the next process. Alternatively it may also be that: the base stations send the report data to the network management system via the base station controllers, and then the network management system forwards the received report data to the NEE indicator in the network management system for further process. Both of the above mentioned two ways can be implemented in a specific application, which way should be employed particularly depends on the design and selection of the data transmission path.

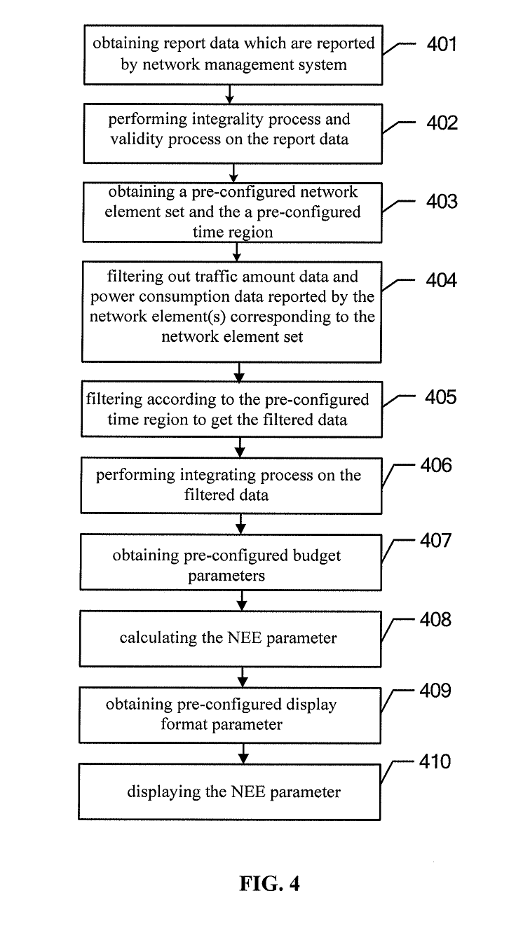

A NEE indicating method according to another embodiment of the present invention will be described in more detail below in conjunction with the implementation manner of FIG. 3. Please refer to FIG. 4, the method according to the another embodiment of the present invention comprises:

401: obtaining report data which are reported by a network management system;

After network element(s) of an access network send the report data to the network management system, the network management system reports the report data to a NEE indicator. It should be noted that the present embodiment is described by way of example that the NEE indicator and the network management system are implemented separately, however it should be understood other implementation ways for the NEE indicator and the network management system may be employed and are not limited herein.

The network element(s) of the access network in the present embodiment may be varying in different systems. For example, the network element(s) of the access network may be base stations, evolved base stations, fixed network access devices and so on, and are not limited herein. The base station is taken as an example in the description herein.

402: performing integrality process and validity process on the report data;

After receiving the report data, the NEE indicator may obtain a pre-analysis rule. In the present embodiment, the pre-analysis rule may be “integrality process and validity process”, then the NEE indicator may perform the integrality process and the validity process on the report data, the process result is taken as the pre-analysis result which includes traffic amount data and power consumption data. The traffic amount data include circuit switch (CS) traffic amount data and/or packet switch (PS) traffic amount data. The power consumption data include the power consumption of the network element(s) of the access network (e.g., the power consumption of the base stations) and/or the power consumption of sites at which the network element(s) of the access network locate (e.g., the power consumption of the base station site).

In the present embodiment, the integrality process is used to select, from the report data, data whose parameter fields are integral or unbroken. The validity process is used to select, from the report data, the normally reported data used for obtaining the NEE parameter.

It should be noted that just one example of the pre-analysis rule is described herein, that is, the NEE indicator performs both the integrality process and the validity process on the report data. It should be understood that if the pre-analysis rule varies, the NEE indicator may operate in other ways accordingly. For example, the NEE indicator just performs the integrality process on the report data or just performs the validity process on the report data, or the NEE indicator may also perform corresponding process according to other pre-analysis rule. The specific pre-analysis rules are not limited herein.

In the present embodiment, the pre-analysis rule may be pre-configured in the NEE indicator, and may also be chosen (for example, chosen from another database storing pre-analysis rules) or set by the user. This is not limited herein.

403: obtaining a pre-configured network element set and a pre-configured time region;

After performing the integrality process and the validity process on the report data, the NEE indicator may further obtain the pre-configured network element set and the pre-configured time region. The network element set indicates the network element(s) for which the user desires to obtain the NEE parameter. The time region includes a start time, an analysis interval and an end time. It should be noted that just one example is described herein, that is, the NEE indicator obtains both the pre-configured network element set and the pre-configured time region. It should be understood that other ways may be employed, for example, the NEE indicator just obtains the pre-configured network element set or just obtains the pre-configured time region. This is not limited herein.

In the present embodiment, the network element set and the time region may be pre-configured in the NEE indicator, and may also be chosen or set by the user. This is not limited herein.

404: filtering out traffic amount data and power consumption data reported by the network element(s) corresponding to the network element set;

The NEE indicator filters the traffic amount data and the power consumption data reported by the network element(s) corresponding to the network element set out of the pre-analysis result.

405: filtering according to the pre-configured time region to get the filtered data;

In the time period from the start time to the end time, the NEE indicator filters the traffic amount data and the power consumption data according to the analysis interval to acquire the filtered data. Here the traffic amount data and the power consumption data being as the object to be filtered may be the traffic amount data and the power consumption data, reported by the network element(s) corresponding to the network element set, which were acquired by filtering at step 404, and may also be the traffic amount data and the power consumption data reported by all the network element(s).

It should be noted that just one example is described in steps 403, 404 and 405 for the NEE indicator to perform pre-analysis process on the report data. In actual applications, after obtaining the pre-configured network element set and the pre-configured time region, the NEE indicator may firstly perform filtering on the pre-analysis result according to the time region at the step 405 and then perform filtering according to the network element set at the step 404 to get the filtered data.

In addition to the above mentioned way of obtaining both the network element set and the time region, in actual applications, it may just obtain the pre-configured network element set, then the step 405 may not be performed and only the step 404 is performed to filter out the traffic amount data and the power consumption data reported by the network element(s) corresponding to the network element set as the filtered data, or it may just obtain the pre-configured time region, then the step 404 may not be performed and only the step 405 is performed to filter according to the pre-configured time region to get the filtered data. The specific filtering ways are not limited herein.

406: performing integrating process on the filtered data;

In the present embodiment, the filtered data are the traffic amount data and the power consumption data filtered out by the NEE indicator according to the pre-configured network element set and the pre-configured time region.

In the present embodiment, the time region is considered. When the analysis interval in the time region is larger than the report interval of the network element(s) of the access network, integrating process may be performed on the filtered data. For example, the report interval of the network element(s) of the access network may be 5 minutes. If the analysis interval is 1 hour, then the filtering at step 405 is performed once an hour. It is not just one filtered data being obtained at each time of filtering, instead it is twelve data in one hour being obtained at each time of filtering. Then the twelve data filtered out in one hour may be accumulated to get integrated data. The integrated data include the traffic amount data and the power consumption data.

407: obtaining pre-configured budget parameters;

The NEE indicator obtains the pre-configured budget parameters which include calculating formula, output defining parameter, traffic type, and power consumption object.

The detailed description is provided below by way of example. b=f (a) denotes that b is as a function of a, wherein the function refers to specific algorithm relationship. The traffic type may be CS traffic, or PS traffic, or total traffic, and the corresponding traffic amount data may be:

Traffic amount: CS traffic amount=f (CS telephone traffic amount), PS traffic amount=f (PS telephone traffic amount), traffic amount=f (CS traffic amount, PS traffic amount);

The power consumption object may be a BTS or a site, and the corresponding power consumption data may be:

power consumption: power consumption b=f (BTS power consumption), power consumption s=f (SITE power consumption);

Calculating formula (NEE parameter defination), for example: NEE_b_cs=CS traffic amount/power consumption b, NEE_b=traffic amount/power consumption b, NEE_s=traffic amount/power consumption s. Of course, the “traffic amount/power consumption” provided here is not limited. In actual applications, other kinds of energy efficiency definition relationship may be employed as long as the energy efficiency definition relationship is at least related to the traffic amount and the power consumption. The specific implementations are not limited herein.

The output defining parameter is the defining format for reprocessing the calculated data. The output defining parameter indicates the output type of the NEE parameter and may include: instant NEE parameter, which is the basic data calculated and output, periodic NEE parameter, maximum NEE parameter, minimum NEE parameter, and so on. More specific output types are not limited herein.

The instant NEE parameter is the NEE parameter calculated at a time instant according to the traffic amount data and the power consumption data of the time instant. The periodic NEE parameter is the NEE parameter calculated according to the sum of all the traffic amount data and the sum of the power consumption data reported during a time period. The maximum NEE parameter and the minimum NEE parameter are respectively the maximum and the minimum among the instant NEE parameters.

In the present embodiment, there is no fixed process sequence between steps 406 and 407. It may perform the step 406 firstly, and may also perform step 407 firstly, or may also perform steps 406 and 407 in parallel. This is not limited herein.

408: calculating the NEE parameter;

The NEE indicator performs calculation on the corresponding traffic amount data and power consumption data according to the calculating formula and the output defining parameter to get the NEE parameter.

409: obtaining pre-configured display format parameter;

After calculating the NEE parameter, the NEE indicator obtains the pre-configured display format parameter. The display format parameter includes one or any combination of the following display formats: graphics display, report form display, data display, and so on.

410: displaying the NEE parameter.

The NEE indicator may display the NEE parameter in the graphics display format, the report form display format, the data display format or the like according to the obtained display format parameter, in order for the user to inquire, output or print.

In the present embodiment, the NEE indicator may acquire the report data from the network element(s), and acquire the valid data used for obtaining the NEE parameter after performing pre-analysis process on the report data. The valid data include traffic amount data and power consumption data. That is, the traffic amount data and the power consumption data need not to be obtained manually, and thus may be monitored and obtained conveniently in real-time, improving the real time performance for obtaining the NEE parameter.

And the NEE indicator calculates the NEE parameter after obtaining the traffic amount data and the power consumption data. Therefore both the process of obtaining the traffic amount data and the power consumption data and the process of calculating the NEE parameter are performed automatically by the NEE indicator. In this way it can reduce the manual workload, save time, decrease the operation cost, and at the same time increase the data accuracy.

Moreover, the NEE indicator may not only output the instant NEE parameter, but also output the periodic NEE parameter, the maximum NEE parameter, the minimum NEE parameter, so that there are various ways to display the NEE.

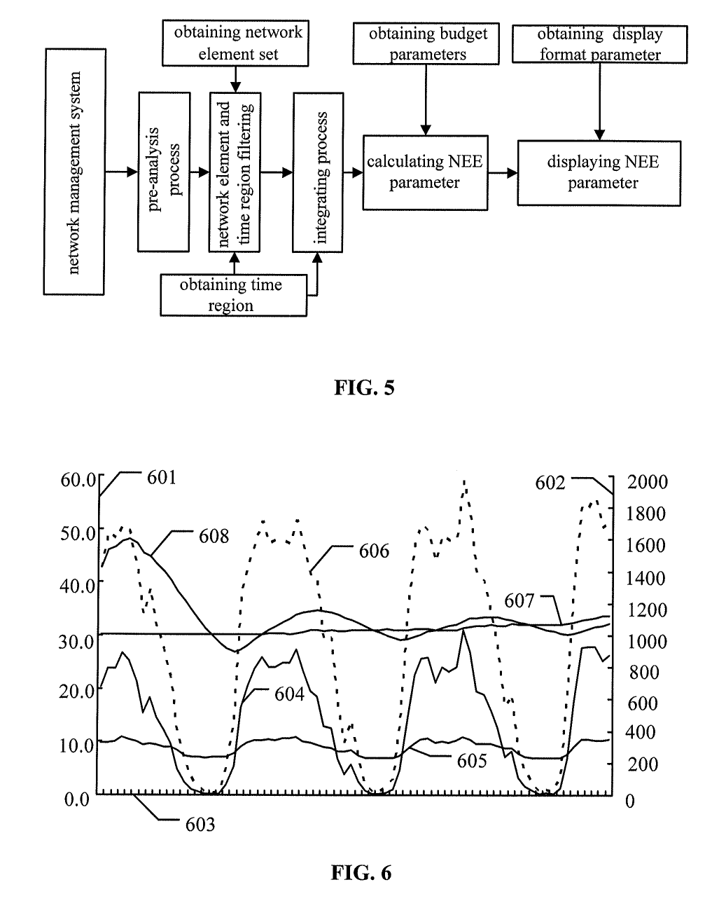

For the sake of providing better understanding to the above mentioned embodiments, the NEE indicator will be described in detail below in a specific application circumstance. Please refer to FIG. 5, particularly:

The NEE indicator receives report data which are reported by base station(s). In the present embodiment, it is described by way of example that the NEE indicator is incorporated in the network management system. However it should be understood that in actual applications the NEE indicator may be implemented separately from the network management system.

In the present embodiment it may assume that there are three base stations, which are base stations A, B and C respectively. All the base stations report to the NEE indicator every 5 minutes periodically. Then in half an hour, the NEE indicator may receive 6 sets of report data from each base station. The format of the report data may be (base station identification (ID), served user number, idle resource condition, time, power consumption, traffic amount). The “base station ID” is the ID of the base station which sent the report data. The “served user number” is the number of users being served currently by the base station. The “idle resource information” indicates how busy the base station is currently. The “time” indicates the time at which the power consumption data and the traffic amount data were acquired. The unit of power consumption may be watt-hour, and the unit of traffic amount may be erl (erlang, the unit of telephone traffic amount).

It should be noted that in the present embodiment, the format of the report data sent by the base station may also be adjusted according to specific cases, and thus is not limited herein.

It assumes that the data reported by base station A may be: (A, 300, busy, 0005, 15, 33), (A, 500, idle, 0010, 18, 36), (A, 300, normal, 0015, 12, NULL), (A, 800, busy, 0020, 15, 40), (A, 900, idle, 0025, 35, 50), (A, 100, idle, 0030, NULL, 20);

It assumes that the data reported by base station B may be: (B, 200, busy, 0005, 33, 33), (B, 900, busy, 0010, 29, 39), (B, 400, idle, 0015, 12, 18), (B, 800, busy, 0020, 34, 76), (B, 500, normal, 0025, 78, 99), (B, 700, busy, 0030, 45, 76);

It assumes that the data reported by base station C may be: (C, 900, busy, 0005, 34, 67), (C, 600, busy, 0010, NULL, 36), (C, 300, busy, 0015, 24, NULL), (C, 400, idle, 0020, 15, NULL), (C, 100, normal, 0025, 00, 50), (C, 600, busy, 0030, 20, 20).

After receiving the report data, the NEE indicator may perform pre-analysis process on the data according to a specific pre-analysis rule. The pre-analysis rule may be a pre-configured rule, or may be a specific pre-analysis rule selected by the user. In the present embodiment, the pre-analysis rule may be “integrality process and validity process”.

The NEE indicator performs integrality process and validity process on the report data. The integrality process is used to select, from the report data, data whose parameter fields are integral. The validity process is used to select, from the report data, the normally reported data used for obtaining the NEE parameter.

For example, the data used for obtaining the NEE parameter may mainly include: “base station ID”, “time”, “power consumption”, and “traffic amount”. The “served user number” and “idle resource condition” reported by the base stations are irrelative for obtaining the NEE parameter, and thus may be omitted. Then the report data used for obtaining the NEE parameter may be determined preliminarily to be:

For base station A: (A, 0005, 15, 33), (A, 0010, 18, 36), (A, 0015, 12, NULL), (A, 0020, 15, 40), (A, 0025, 35, 50), (A, 0030, NULL, 20);

For base station B: (B, 0005, 33, 33), (B, 0010, 29, 39), (B, 0015, 12, 18), (B, 0020, 34, 76), (B, 0025, 78, 99), (B, 0030, 45, 76);

For base station C: (C, 0005, 34, 67), (C, 0010, NULL, 36), (C, 0015, 24, NULL), (C, 0020, 15, NULL), (C, 0025, 00, 50), (C, 0030, 20, 20).

Another respect of the validity process may specifically includes: eliminating exceptional data from the report data, for example, such data as “power consumption is 0 while having traffic amount” may be eliminated.

Since data loss may occur during the transmission of the report data, the integrality process is used for eliminating some report data which have empty parameter field (NULL).

After the above mentioned integrality process and the validity process, it may determine that the following report data do not conform to the requirement: (A, 0015, 12, NULL), (A, 0030, NULL, 20), (C, 0010, NULL, 36), (C, 0015, 24, NULL), (C, 0020, 15, NULL), (C, 0025, 00, 50).

And the pre-analysis result obtained after the pre-analysis process may be: (A, 0005, 15, 33), (A, 0010, 18, 36), (A, 0020, 15, 40), (A, 0025, 35, 50), (B, 0005, 33, 33), (B, 0010, 29, 39), (B, 0015, 12, 18), (B, 0020, 34, 76), (B, 0025, 78, 99), (B, 0030, 45, 76), (C, 0005, 34, 67), (C, 0030, 20, 20).

After getting the pre-analysis result, the pre-analysis result may be filtered. In the present invention it is described by way of example that both the network element set filtering and the time region filtering are performed.

It assumes that the network element set may be “base stations around the railway station”, the time region may be “star time 0005, analysis interval 10 minutes, end time 0030”. It should be noted that the network element set and the time region may be pre-configured in the NEE indicator, and may also be chosen or set by the user.

After obtaining the network element set and the time region, the NEE indicator may determine network element(s) conforming to the requirement of the network element set. Assuming that the base station B is located near the railway station, then it determines that the base station B conforms to the requirement of the network element set, so that the result acquired after the preliminary filtering may be: (B, 0005, 33, 33), (B, 0010, 29, 39), (B, 0015, 12, 18), (B, 0020, 34, 76), (B, 0025, 78, 99), (B, 0030, 45, 76).

Then the data conforming to the requirement of the time region may be chosen out of the report data sent from the base station B according to the time region. In the present embodiment, since the analysis interval is 10 minutes while the base station's reporting period is 5 minutes, the result of filtering according to the time region is not the instant data every 10 minutes, but instead is all the data in the 10 minutes, and particularly may be: [(B, 0005, 33, 33), (B, 0010, 29, 39)], [(B, 0015, 12, 18), (B, 0020, 34, 76)], and [(B, 0025, 78, 99), (B, 0030, 45, 76)]. These data are taken as the filtered data.

After getting the filtered data, the NEE indicator may perform integrating process on the filtered data and may also obtain budget parameters at the same time. The budget parameters include calculating formula, output defining parameter, traffic type and power consumption object.

In the present embodiment, the integrating process is used for accumulating the data in the analysis interval according to the analysis interval. Then the integrated data obtained after the integrating process may be: (B, 0005˜0010, 62, 72), (B, 0015˜4020, 46, 94), and (B, 0025˜0030, 123, 175).

In the present embodiment, it assumes that the traffic type is “total traffic amount data”, the power consumption object is “base station”, and the calculating formula is “NEE parameter=traffic amount/power consumption”, the output defining parameter is “periodic NEE parameter”.

It should be noted that, the traffic amount data in the report data sent from the base stations may be CS-domain traffic amount data, may also be PS-domain traffic amount data, and may also include both CS-domain traffic amount data and PS-domain traffic amount data. The power consumption data in the report data sent from the base staions may be the power consumption data of the base stations, and may also be the power consumption data of sites at which the base stations locate.

In the present embodiment it is described by way of example that the traffic amount data in the report data sent from the base stations are total traffic amount and the power consumption data are the power consumption of the base stations. After determining the budget parameters, the NEE indicator may calculate the NEE parameter according to the budget parameters and the filtered data, i.e., (B, 0005˜0010, 62, 72), (B, 0015˜0020, 46, 94) and (B, 0025˜0030, 123, 175). The specific calculating process may be:

For base station B, its periodic NEE parameter may be divided into three sections, that is, NEE parameter in the period from 0001 time instant to 0010 time instant, NEE parameter in the period from 0011 time instant to 0020 time instant, and NEE parameter in the period from 0021 time instant to 0030 time instant, the specific data values may be:

0001˜0010 period: NEE parameter=72/62;

0011˜4020 period: NEE parameter=94/46;

0021˜0030 period: NEE parameter=175/123.

After calculating the NEE parameter, the NEE indicator may obtain a display format parameter. The display format parameter may be pre-configured in the NEE indicator, and may also be chosen and input by the user. The display format parameter indicates what kind of format will be employed to display the calculated NEE parameter. For example, the display format may be graphics display, report form display, data display and so on, and is not limited herein.

When the calculated NEE parameter is displayed by way of graphics display, the output effect may be as shown in FIG. 6. It should be noted that, in order for easy viewing and clearly describing, the specific data displayed in the graphic of FIG. 6 in the present embodiment do not depend on the data provided in the above mentioned example.

In FIG. 6, data axis 601 denotes traffic amount, data axis 602 denotes power consumption, data axis 603 denotes time, curve line 604 denotes the telephone traffic amount changing curve line, curve line 605 denotes the power consumption changing curve line, curve line 606 denotes the changing curve line of the instant NEE parameters at different time instants, curve line 607 denotes the changing curve line of the per day averaged values of the NEE parameters, curve line 608 denotes the changing curve line of the averaged values of the accumulated NEE parameters.

The traffic amount denoted by data axis 601 may specifically be CS traffic amount=f(CS telephone traffic amount);

The power consumption denoted by data axis 602 may specifically be power consumption b of the BTS;

The time denoted by data axis 603 may specifically be pre-configured time interval scales in unit of hour;

The telephone traffic amount changing curve line denoted by curve line 604 may specifically be the base station reported data obtained after the integrating calculation;

The power consumption changing curve line denoted by curve line 605 may specifically be the base station reported power consumption b=f(BTS power consumption) obtained after the integrating calculation;

The instant NEE parameter changing curve line denoted by curve line 606 may specifically be the values of CS traffic amount/power consumption b obtained after the integrating calculation in every one hour;

The changing curve line of the per day averaged values of the NEE parameters denoted by curve line 607 may specifically be the values of the total CS traffic amount in the previous 24 hours/the total power consumption b in the previous 24 hours;

The changing curve line of the averaged values of the accumulated NEE parameters denoted by curve line 608 may specifically be: the total CS traffic amount in the time period from the start time to the current time/the total power consumption b in the time period from the start time to the current time.

In the present embodiment, the NEE indicator may acquire the report data from the network elements, and acquire valid data used for obtaining NEE parameter after performing pre-analysis process on the report data. The valid data include traffic amount data and power consumption data. That is, the traffic amount data and the power consumption data need not to be obtained manually, and thus may be monitored and obtained conveniently in real-time, improving the real time performance for obtaining the NEE parameter.

And the NEE indicator calculates the NEE parameter after obtaining the traffic amount data and the power consumption data. Therefore both the process of obtaining the traffic amount data and the power consumption data and the process of calculating the NEE parameters are performed automatically by the NEE indicator. In this way it can reduce the manual workload, save time, decrease the operation cost, and at the same time increase the data accuracy.

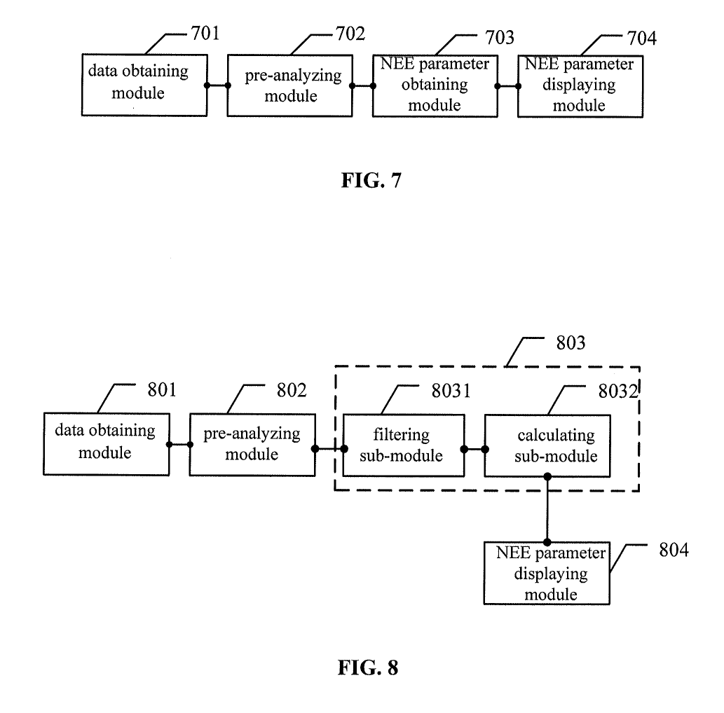

The NEE indicating method according to the embodiments of the present invention is described above, and the NEE indicator will be described in the following. Please refer to FIG. 7, an example of the NEE indicator according to embodiments of the present invention comprises:

a data obtaining module 701 for obtaining report data which are reported by one or more network elements;

a pre-analyzing module 702 for performing pre-analysis process on the report data to get valid data used for acquiring NEE parameters, the valid data may be taken as pre-analysis result which includes traffic amount data and power consumption data;

a NEE parameter obtaining module 703 for obtaining the NEE parameter according to the traffic amount data and the power consumption data;

a NEE parameter displaying module 704 for displaying the acquired NEE parameter.

The interaction process among the respective modules is described by way of an application example.

The data obtaining module 701 acquires the report data which are reported by the one or more network elements. The report data may be massive data which are reported by the one or more network elements according to a default protocol, and may also be data which are reported by the one or more network elements according to the request of the NEE indicator. This is not limited herein.

The pre-analyzing module 702 performs pre-analysis process on the report data obtained by the data obtaining module 701 to get the valid data used for obtaining the NEE parameter. The valid data may be taken as pre-analysis result which includes traffic amount data and power consumption data.

The NEE parameter obtaining module 703 obtains the NEE parameter according to the pre-analysis result of the pre-analyzing module 702. It can be seen from the definition of the NEE parameter, the values of the NEE parameter are related to the traffic amount data and the power consumption data. Therefore the NEE parameter may be obtained according to the traffic amount data and the power consumption data. The specific way for obtaining the NEE parameter is not limited herein.

The NEE parameter displaying module 704 displays the NEE parameter obtained by the NEE parameter obtaining module 703, in order for the user to inquire, output or print.

In the present embodiment, the data obtaining module 701 may acquire the report data from the network element(s), and the pre-analyzing module 702 may get the valid data used for obtaining the NEE parameter after performing pre-analysis process on the report data. The valid data include traffic amount data and power consumption data. That is, the traffic amount data and power consumption data need not to be obtained manually, and thus may be monitored and obtained conveniently in real-time, improving the real time performance for obtaining the NEE parameter.

And the NEE parameter obtaining module 703 calculates the NEE parameter after the traffic amount data and the power consumption data are obtained. Therefore both the process of obtaining the traffic amount data and the power consumption data and the process of calculating the NEE parameter are completed automatically by the NEE indicator. In this way it can reduce the manual workload, save time, decrease the operation cost, and at the same time increase the data accuracy.

For the sake of facilitating understanding, a NEE indicator according to another embodiment of the present invention will be described below in conjunction with FIG. 8. The NEE indicator according to the another embodiment of the present invention comprises:

a data obtaining module 801 for obtaining report data which are reported by network element(s);

a pre-analyzing module 802 for performing pre-analysis process on the report data to get valid data used for acquiring the NEE parameter, the valid data may be taken as pre-analysis result which includes traffic amount data and power consumption data;

a NEE parameter obtaining module 803 which includes: a filtering sub-module 8031 for filtering the traffic amount data and the power consumption data to get the filtered data; and a calculating sub-module 8032 for performing calculation on the filtered data to acquire the NEE parameter;

a NEE parameter displaying module 804 for displaying the acquired NEE parameter.

Comparing with the above mentioned embodiment as shown in FIG. 7, the filtering sub-module is added in the present embodiment. Therefore the present embodiment further has the following advantageous effects in addition to the advantageous effects presented in the above mentioned embodiment as shown in FIG. 7:

In the present embodiment, after performing pre-analysis process on the report data to acquire the pre-analysis result, the NEE indicator may also filter the pre-analysis result. In this way specific data used for calculating the NEE parameter may be filtered out of the pre-analysis result, and thus it may improve the flexibility and pertinence of the process for calculating the NEE parameter.

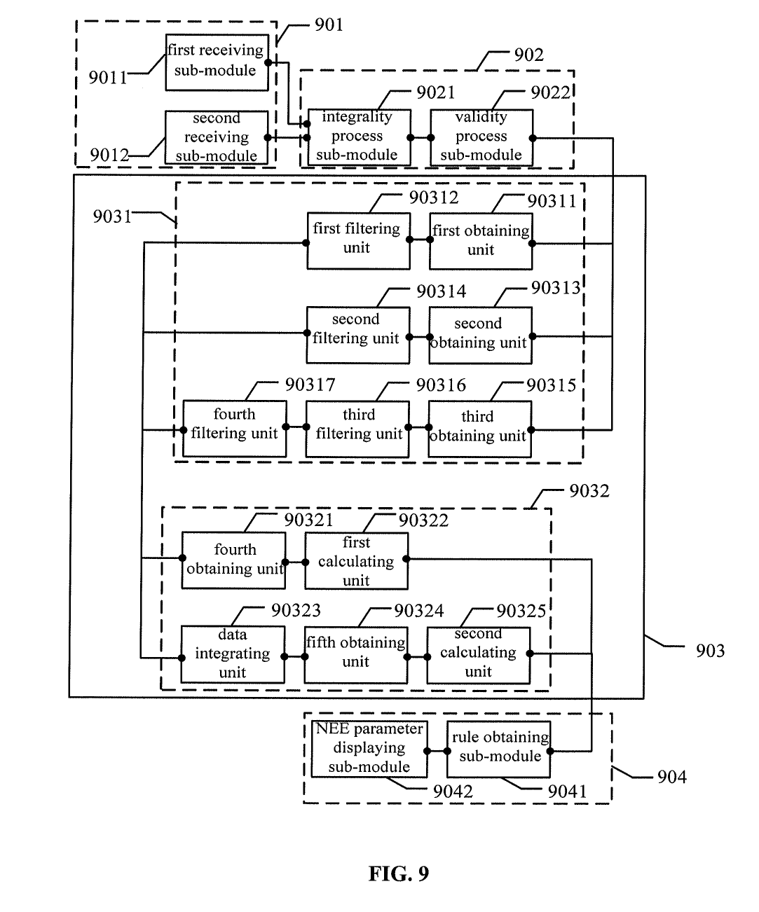

For the sake of facilitating understanding in more detail, a NEE indicator according to another embodiment of the present invention will be described below in conjunction with FIG. 9. The NEE indicator according to the another embodiment of the present invention comprises:

a data obtaining module 901 which includes: a first receiving sub-module 9011 for receiving report data which are reported by network element(s) of the access network, or a second receiving sub-module 9012 for receiving report data which are reported by the network management system, wherein the report data which are reported by the network management system are sent from the network element(s) of the access network to the network management system;

a pre-analyzing module 902 which includes: an integrality process sub-module 9021 for performing integrality process on the report data, wherein the integrality process is used to select, from the report data, data whose parameter fields are integral, and/or a validity process sub-module 9022 for performing validity process on the report data, wherein the validity process is used to select, from the report data, the normally reported data used for obtaining the NEE parameter;

a NEE parameter obtaining module 903 which includes a filtering sub-module 9031 and a calculating sub-module 9032,

the filtering sub-module 9031 includes:
a first obtaining unit 90311 for obtaining a pre-configured network element set, the network element set indicates the network element(s) for which the user desires to obtain the NEE parameter; and a first filtering unit 90312 for filtering, out of the traffic amount data and the power consumption data, traffic amount data and power consumption data reported by the network element(s) corresponding to the network element set as the filtered data;
or
a second obtaining unit 90313 for obtaining a pre-configured time region, the time region includes a start time, an analysis interval and an end time;
a second filtering unit 90314 for filtering the traffic amount data and the power consumption data in the time period from the start time to the end time according to the analysis interval to acquire the filtered data;
or
a third obtaining unit 90315 for obtaining both a pre-configured network element set and a pre-configured time region, the network element set indicates the network element(s) for which the user desires to obtain the NEE parameter, and the time region includes a start time, an analysis interval and an end time;
a third filtering unit 90316 for filtering, out of the traffic amount data and the power consumption data, traffic amount data and power consumption data reported by the network element(s) corresponding to the network element set;
a fourth filtering unit 90317 for filtering the traffic amount data and the power consumption data reported by the network element(s) corresponding to the network element set, which were filtered out by the third filtering unit 90316, in the time period from the start time to the end time according to the analysis interval to acquire the filtered data;

a calculating sub-module 9032 which includes:
a fourth obtaining unit 90321 for obtaining pre-configured budget parameters, which include calculating formula, output defining parameter, traffic type, and power consumption object, the output defining parameter indicates the output type of the NEE parameter;
a first calculating unit 90322 for obtaining traffic amount data corresponding to the traffic type and power consumption data corresponding to the power consumption object from the filtered data, and performing calculation on the obtained traffic amount data and power consumption data according to the calculating formula and the output defining parameter to get the NEE parameter;
or
a data integrating unit 90323 for performing integrating process on the filtered data to get the integrated data, which include traffic amount data and power consumption data;
a fifth obtaining unit 90324 for obtaining pre-configured budget parameters, which include calculating formula, output defining parameter, traffic type, and power consumption object, the output defining parameter indicates the output type of the NEE parameter;
a second calculating unit 90325 for obtaining traffic amount data corresponding to the traffic type and power consumption data corresponding to the power consumption object from the integrated data, and performing calculation on the obtained traffic amount data and power consumption data according to the calculating formula and the output defining parameter to get the NEE parameter;

a NEE parameter displaying module 904 which includes:
a rule obtaining sub-module 9041 for obtaining a pre-configured display format parameter, the display format parameter includes graphics display, report form display, data display;
a NEE parameter displaying sub-module 9042 for displaying the NEE parameter according to the displaying rule.

The interaction process among the respective modules is described below by way of an application example.

The first receiving sub-module 9011 receives the report data which are reported by the network element(s) of the access network, or the second receiving sub-module 9012 receives the report data which are reported by the network management system.

The pre-analyzing module 902 performs pre-analysis process on the report data. The specific pre-analysis process includes performing integrality process on the report data by the integrality process sub-module 9021, and/or performing validity process on the report data by the validity process sub-module 9022.

The filtering sub-module 9031 in the NEE parameter obtaining module 903 filters the pre-analysis result to get the filtered data. The calculating sub-module 9032 in the NEE parameter obtaining module 903 performs calculation on the filtered data to get the NEE parameter.

In the present embodiment, the specific process of filtering the pre-analysis result by the filtering sub-module 9031 to get the filtered data may be:

the first obtaining unit 90311 in the filtering sub-module 9031 obtains the pre-configured network element set, and the first filtering unit 90312 in the filtering sub-module 9031 filters, out of the traffic amount data and the power consumption data, traffic amount data and power consumption data reported by the network element(s) corresponding to the network element set as the filtered data; or

the second obtaining unit 90313 in the filtering sub-module 9031 obtains the pre-configured time region, and the second filtering unit 90314 in the filtering sub-module 9031 filters the traffic amount data and the power consumption data in the time period from the start time to the end time according to the analysis interval to acquire the filtered data; or

the third obtaining unit 90315 in the filtering sub-module 9031 obtains the pre-configured network element set and the pre-configured time region, the third filtering unit 90316 in the filtering sub-module 9031 filters, out of the traffic amount data and the power consumption data, traffic amount data and power consumption data reported by the network element(s) corresponding to the network element set, and the fourth filtering unit 90317 in the filtering sub-module 9031 filters the traffic amount data and the power consumption data reported by the network element(s) corresponding to the network element set in the time period from the start time to the end time according to the analysis interval to acquire the filtered data.

In the present embodiment, the specific process of performing calculation on the filtered data by the calculating sub-module 9032 to get the NEE parameter may be:

the fourth obtaining unit 90321 in the calculating sub-module 9032 obtains the pre-configured budget parameters, the first calculating unit 90322 in the calculating sub-module 9032 obtains the traffic amount data corresponding to the traffic type and the power consumption data corresponding to the power consumption object from the filtered data, and performs calculation on the obtained traffic amount data and power consumption data according to the calculating formula and the output defining parameter to get the NEE parameter; or

the data integrating unit 90323 in the calculating sub-module 9032 performs integrating process on the filtered data to get the integrated data, the fifth obtaining unit 90324 in the calculating sub-module 9032 obtains the pre-configured budget parameters, the second calculating unit 90325 in the calculating sub-module 9032 obtains the traffic amount data corresponding to the traffic type and the power consumption data corresponding to the power consumption object from the integrated data, and performs calculation on the obtained traffic amount data and power consumption data according to the calculating formula and the output defining parameter to get the NEE parameter.

After the NEE parameter obtaining module 903 obtains the NEE parameter, the NEE parameter displaying module 904 displays the obtained NEE parameter, the displaying process includes: the rule obtaining sub-module 9041 obtains the pre-configured display format parameter, and the NEE parameter displaying sub-module 9042 displays the NEE parameter according to the displaying rule.

In the present embodiment, the NEE indicator may acquire the report data from the network element(s), and acquire valid data used for obtaining the NEE parameter after performing pre-analysis process on the report data. The valid data include traffic amount data and power consumption data. That is, the traffic amount data and the power consumption data need not to be obtained manually, and thus may be monitored and obtained in real-time, improving the real time performance for obtaining the NEE parameter.

And the NEE indicator calculates the NEE parameter after obtaining the traffic amount data and the power consumption data. Therefore both the process of obtaining the traffic amount data and the power consumption data and the process of calculating the NEE parameter are completed automatically by the NEE indicator. In this way it can reduce the manual workload, save time, decrease the operation cost, and at the same time increase the data accuracy.

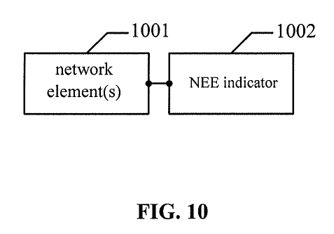

The NEE indicator is introduced in the above mentioned embodiments, and a NEE indicating system is described below in conjunction with FIG. 10. A NEE indicating system according to an embodiment of the present invention includes:

network element(s) 1001 acting as the object to be monitored for NEE;

a NEE indicator 1002, the NEE indicator 1002 in the present embodiment is identical with those as shown in the FIG. 7 or 8 or 9 and thus is not described in detail here.

It should be noted that, in actual applications, the NEE indicator 1002 may be incorporated in the network management system, and may also be implemented separately from the network management system, particularly:

When the NEE indicator 1002 is incorporated in the network management system, the NEE indicator 1002 acts as a unit or a module in the network management system. In this way, the NEE indicator 1002 may directly receive the report data sent by the network element(s) 1001, and calculate and display the NEE parameter.

When the NEE indicator 1002 is implemented separately from the network management system, the NEE indicating system includes not only the above mentioned interaction between the network element(s) 1001 and the NEE indicator 1002, but also the interaction with the network management system. The network element(s) 1001 may send the report data to the network management system, and then the network management system forwards the received report data to the NEE indicator 1002, which then calculates and displays the NEE parameter.

In the present embodiment, the NEE indicator 1002 may acquire the report data from the network element(s), and acquire valid data used for obtaining the NEE parameter after performing pre-analysis process on the report data. The valid data include traffic amount data and power consumption data. That is, the traffic amount data and the power consumption data need not to be obtained manually, and thus may be monitored and obtained in real-time, improving the real time performance for obtaining the NEE parameter.

And the NEE indicator 1002 calculates the NEE parameter after obtaining the traffic amount data and the power consumption data. Therefore both the process of obtaining the traffic amount data and the power consumption data and the process of calculating the NEE parameter are completed automatically by the NEE indicator 1002. In this way it can reduce the manual workload, save time, decrease the operation cost, and at the same time increase the data accuracy.

Those skilled in the art may understand that all or part of the steps in one of the methods as provided in the above mentioned embodiments may be implemented by related hardware under the instructions of program. The program may be stored in computer readable storage medium. The storage medium may be read only memory, magnetic disk or compact disc.

A NEE indicating method, indicator and system provided by the present invention are described in details above. Those skilled in the art with common knowledge can make change to the specific embodiments and the application scopes in light of the principle of the embodiments of the present invention, therefore the contents in the specification should not be regarded as limitation to the present invention.

1. A method for indicating network energy efficiency (NEE), comprising:
obtaining report data which are reported by one or more network elements;
performing a pre-analysis process on the report data to get valid data used for obtaining a NEE parameter, wherein the valid data are taken as a pre-analysis result, and the pre-analysis result includes traffic amount data and power consumption data;
obtaining the NEE parameter according to the traffic amount data and the power consumption data; and
displaying the obtained NEE parameter.

2. The method according to claim 1, wherein the obtaining report data which are reported by one or more network elements comprises one of:
receiving the report data which are reported by one or more network elements of an access network;
or
receiving the report data which are reported by a network management system, wherein the report data which are reported by the network management system are sent from the one or more network elements of the access network to the network management system.

3. The method according to claim 1, wherein the performing a pre-analysis process on the report data comprises:
performing at least one of an integrality process and a validity process on the report data, wherein the integrality process is used to select, from the report data, data whose parameter fields are integral, the validity process is used to select, from the report data, normally reported data used for obtaining the NEE parameter.

4. The method according to claim 2, wherein the performing a pre-analysis process on the report data comprises:
performing at least one of an integrality process and a validity process on the report data, wherein the integrality process is used to select, from the report data, data whose parameter fields are integral, the validity process is used to select, from the report data, normally reported data used for obtaining the NEE parameter.

5. The method according to claim 1, wherein the obtaining the NEE parameter according to the traffic amount data and the power consumption data comprises:
filtering the traffic amount data and the power consumption data to get filtered data; and
performing calculation on the filtered data to get the NEE parameter.

6. The method according to claim 3, wherein the obtaining the NEE parameter according to the traffic amount data and the power consumption data comprises:
filtering the traffic amount data and the power consumption data to get filtered data; and
performing calculation on the filtered data to get the NEE parameter.

7. The method according to claim 5, wherein the filtering the traffic amount data and the power consumption data to get the filtered data comprises:
obtaining a pre-configured network element set, wherein the network element set indicates one or more network elements for which a user desires to obtain the NEE parameter, and
filtering, out of the traffic amount data and the power consumption data, traffic amount data and power consumption data reported by the one or more network elements corresponding to the network element set as the filtered data,
or
obtaining a pre-configured time region, the time region includes a start time, an analysis interval and an end time, and
filtering the traffic amount data and the power consumption data in a time period from the start time to the end time according to the analysis interval, to get the filtered data;
or
obtaining both a pre-configured network element set and a pre-configured time region, the network element set indicates one or more network elements for which a user desires to obtain the NEE parameter, and the time region includes a start time, an analysis interval and an end time,
filtering, out of the traffic amount data and the power consumption data, traffic amount data and power consumption data reported by the one or more network elements corresponding to the network element set, and
filtering the traffic amount data and the power consumption data reported by the one or more network elements corresponding to the network element set in a time period from the start time to the end time according to the analysis interval to get the filtered data.

8. The method according to claim 7, wherein
when the filtering is performed according to the pre-configured network element set, the performing calculation on the filtered data to get the NEE parameter comprises:
obtaining pre-configured budget parameters, the budget parameters include calculating formula, output defining parameter, traffic type, and power consumption object, the output defining parameter indicates output type of the NEE parameter,
obtaining traffic amount data corresponding to the traffic type and power consumption data corresponding to the power consumption object from the filtered data, and
performing calculation on the obtained traffic amount data and power consumption data according to the calculating formula and the output defining parameter, to get the NEE parameter;
or,
when the filtering is performed according to the pre-configured time region, or when the filtering is performed according to both the pre-configured network element set and the pre-configured time region, the performing calculation on the filtered data to get the NEE parameter comprises:
performing an integrating process on the filtered data to get integrated data, the integrated data include traffic amount data and power consumption data,
obtaining pre-configured budget parameters, the budget parameters include calculating formula, output defining parameter, traffic type, and power consumption object, the output defining parameter indicates output type of the NEE parameter,
obtaining traffic amount data corresponding to the traffic type and power consumption data corresponding to the power consumption object from the integrated data, and
performing calculation on the obtained traffic amount data and power consumption data according to the calculating formula and the output defining parameter, to get the NEE parameter.

9. The method according to claim 1, wherein the displaying the obtained NEE parameter comprises:
obtaining a pre-configured display format parameter, the display format parameter includes one or any combination of the following display formats: graphics display, report form display, and data display; and
displaying the NEE parameter according to the display format parameter.

10. The method according to claim 1, wherein the traffic amount data comprise at least one of circuit switch (CS) traffic amount data and packet switch (PS) traffic amount data;
the power consumption data comprise power consumption of the one or more network elements of an access network and/or power consumption of sites at which the one or more network elements of the access network locate.

11. A network energy efficiency (NEE) indicator, comprising:
a data obtaining module for obtaining report data which are reported by one or more network elements;
a pre-analyzing module for performing a pre-analysis process on the report data to get valid data used for obtaining a NEE parameter, wherein the valid data are taken as a pre-analysis result, and the pre-analysis result includes traffic amount data and power consumption data;
a NEE parameter obtaining module for obtaining the NEE parameter according to the traffic amount data and the power consumption data; and
a NEE parameter displaying module for displaying the obtained NEE parameter.

12. The NEE indicator according to claim 11, wherein
the data obtaining module comprises one of:
a first receiving sub-module for receiving the report data which are reported by the one or more network elements of an access network;
or,
a second receiving sub-module for receiving the report data which are reported by a network management system, wherein the report data which are reported by the network management system are sent from the one or more network elements of the access network to the network management system.

13. The NEE indicator according to claim 11, wherein the pre-analyzing module comprises at least one of:
an integrality process sub-module for performing an integrality process on the report data, wherein the integrality process is used to select, from the report data, data whose parameter fields are integral;
and,
a validity process sub-module for performing a validity process on the report data, wherein the validity process is used to select, from the report data, normally reported data used for obtaining the NEE parameter.

14. The NEE indicator according to claim 11, wherein the NEE parameter obtaining module comprises:
a filtering sub-module for filtering the traffic amount data and the power consumption data to get filtered data; and
a calculating sub-module for performing a calculation on the filtered data to get the NEE parameter.

15. The NEE indicator according to claim 14, wherein
the filtering sub-module comprises:
a first obtaining unit for obtaining a pre-configured network element set, the network element set indicates one or more network elements for which a user desires to obtain the NEE parameter, and
a first filtering unit for filtering, out of the traffic amount data and the power consumption data, traffic amount data and power consumption data reported by the one or more network elements corresponding to the network element set as the filtered data;
or
the filtering sub-module comprises:
a second obtaining unit for obtaining a pre-configured time region, the time region includes a start time, an analysis interval and an end time, and
a second filtering unit for filtering the traffic amount data and the power consumption data in a time period from the start time to the end time according to the analysis interval, to get the filtered data;
or
the filtering sub-module comprises:
a third obtaining unit for obtaining both a pre-configured network element set and a pre-configured time region, the network element set indicates one or more network elements for which a user desires to obtain the NEE parameter, and the time region includes a start time, an analysis interval and an end time,
a third filtering unit for filtering, out of the traffic amount data and the power consumption data, traffic amount data and power consumption data reported by the one or more network elements corresponding to the network element set, and
a fourth filtering unit for filtering the traffic amount data and the power consumption data reported by the one or more network elements corresponding to the network element set, which are filtered out by the third filtering unit, in a time period from the start time to the end time according to the analysis interval to get the filtered data.

16. The NEE indicator according to claim 15, wherein
when the filtering is performed according to the pre-configured network element set, the calculating sub-module comprises:
a fourth obtaining unit for obtaining pre-configured budget parameters, the budget parameters include calculating formula, output defining parameter, traffic type, and power consumption object, the output defining parameter indicates output type of the NEE parameter, and
a first calculating unit for obtaining traffic amount data corresponding to the traffic type and power consumption data corresponding to the power consumption object from the filtered data, and performing calculation on the obtained traffic amount data and power consumption data according to the calculating formula and the output defining parameter to get the NEE parameter;
or,
when the filtering is performed according to the pre-configured time region, or when the filtering is performed according to both the pre-configured network element set and the pre-configured time region, the calculating sub-module comprises:
a data integrating unit for performing an integrating process on the filtered data to get integrated data, the integrated data include traffic amount data and power consumption data,
a fifth obtaining unit for obtaining pre-configured budget parameters, the budget parameters include calculating formula, output defining parameter, traffic type, and power consumption object, the output defining parameter indicates output type of the NEE parameter, and
a second calculating unit for obtaining traffic amount data corresponding to the traffic type and power consumption data corresponding to the power consumption object from the integrated data, and performing calculation on the obtained traffic amount data and power consumption data according to the calculating formula and the output defining parameter to get the NEE parameter.

17. The NEE indicator according to claim 11, wherein the NEE parameter displaying module comprises:
a rule obtaining sub-module for obtaining a pre-configured display format parameter, the display format parameter includes one or any combination of the following display formats: graphics display, report form display, and data display; and
a NEE parameter displaying sub-module for displaying the NEE parameter according to the display format parameter.

18. A network energy efficiency (NEE) indicating system, comprising the NEE indicator according to claim 11 and one or more network elements acting as the objects to be monitored for NEE.

19. The NEE indicator system according to claim 18, wherein
the data obtaining module comprises one of:
a first receiving sub-module for receiving the report data which are reported by the one or more network elements of an access network;
or,
a second receiving sub-module for receiving the report data which are reported by a network management system, wherein the report data which are reported by the network management system are sent from the one or more network elements of the access network to the network management system.

20. The NEE indicator system according to claim 18, wherein the pre-analyzing module comprises at least one of:
an integrality process sub-module for performing an integrality process on the report data, wherein the integrality process is used to select, from the report data, data whose parameter fields are integral;
and
a validity process sub-module for performing a validity process on the report data, wherein the validity process is used to select, from the report data, normally reported data used for obtaining the NEE parameter.
